(19) United States
(12) Patent Application Publication
(10) Pub. No.: US 2003/0085784 A1
(43) Pub. Date: May 8, 2003

(54) Relay

(76) Inventor: Robert Weber, Schaffhausen (CH)

Correspondence Address: BURNS, DOANE, SWECKER & MATHIS, L.L.P., P.O. Box 1404, Alexandria, VA, 22313-1404, US

(21) Appl. No.: 10/287,545

(22) Filed: Nov. 5, 2002

(30) Foreign Application Priority Data
Nov. 6, 2001 (CH) 2001 2037/01

(51) Int. Cl. H01H 67/02

(52) U.S. Cl. 335/129

(57) ABSTRACT

An activator is arranged on, in or at a slide which is common to the contacts of a relay. A sensor, which can be activated by means of the activator, is arranged in the vicinity of the slide. Using the contactless generation of a control signal by the activator in the sensor during the monitoring of the switched position, or the switching movement of the contacts, an adjustment of the monitoring device is possible electronically and/or by the change of the location of the elements of the monitoring device. This reduces the adjustment outlay considerably and allows the reduction of the drive mechanism, since fewer springs need to be moved and therefore the force required for switching the relay is reduced.

### BACKGROUND

1. FIELD OF THE INVENTION

The invention relates to a relay having a plurality of load contacts, each with a movable contact spring, a slide, which is in engagement with the movable contact springs of the load contacts, and a drive mechanism for driving the slide for the purpose of switching the load contacts by means of the slide, and a contactless monitoring device in the housing of the relay for monitoring the switching of the load contacts.

2. Background Information

A contactor is known from U.S. Pat. No. 3,821,771, which has a base plate, a housing on it and an actuating structure in the housing. This actuating structure has a U-shaped yoke with a coil winding of a coil on each leg of the U. The U-shaped yoke acts together with a U-shaped armature. The contactor has a row of stationary contact pairs, and a movable contact bridge for each stationary contact pair. The contact bridges are arranged on a movable contact carrier. The stationary contacts are arranged on the housing of the contactor. The contact carrier and the contact bridges are displaced, together with the armature, in relation to the housing when the coil is activated or deactivated. When the coil is activated, the contacts are closed by the electromagnet. When the coil is deactivated, the contacts are opened by means of the spring force of two helical springs. Such a contactor has merely a number of make-contact elements as load contacts, but no break-contact element as the control contact.

An add-on contact device for such a contactor is known from U.S. Pat. No. 4,309,683. This add-on contact device has a second housing which can be attached to the first housing of the contactor. A fixed and a movable contact are arranged on a second contact carrier in this second housing. The first contact carrier of the contactor and the second contact carrier of the add-on contact device are mechanically coupled, so that the second contact carrier is forced to go along with the movements of the first contact carrier. In the process the contact of the add-on contact device is closed or opened. Slits are provided in the first contact carrier for the connection of the two contact carriers, while protrusions are provided in the second contact carrier, which enter into these slits. The connection of the contact carrier of the add-on contact device with the contact carrier of the contactor makes it possible to omit spring means in the add-on contact device.

U.S. Pat. No. 5,198,789 proposes to add a logical safety switch to a contactor in accordance with U.S. Pat. No. 3,821,771, which can be connected with a contact in the manner of the add-on contact device in accordance with U.S. Pat. No. 4,309,683. This safety switch has a striker projecting out of the housing of the safety switch, which picks up the movements of the armature and therefore is moved back and forth between the opened position and the closed position of the contacts. Logical sensors are arranged around the striker in the housing, and an activator on the striker. Depending on the position of the armature, the activator selectively activates the logical sensors, which sensors therefore generate a logical signal corresponding to the position of the contact bridges. A permanent magnet and reed switch, an optical waveguide on the striker and an optical transmitter and receiver around the striker, a magnet and inductive sensors are proposed as activators and sensors. In a preferred embodiment the striker has its own spring means which press the striker against the armature, so that the safety switch does not put a load on the helical springs of the contactor.

An additional electronic contact for a contactor is known from WO 92/00599 A1. The additional contact has at least one switching element, which can have an “ON” and an “OFF” state in order to indicate the position of a contact bridge in the contactor. The additional contact furthermore has an actuating element which is mechanically connected with the contact bridge and can actuate the switching element. In this case the actuating element has an activator, which has no mechanical connection with the switching element, for activating the switching element. The additional contact is arranged on a housing block on the exterior of the contactor. The actuating element extends with a pin into the interior of the contactor and is fastened there on the contact carrier. Because of the movement of the contact carrier, a carriage connected with the pin is displaced, together with the pin, by the same distance as the contact carrier inside the housing block. The position of the carrier is detected by sensors. Hall sensors, inductive or capacitive proximity sensors, as well as optical distance sensors, are proposed as sensors.

The drive mechanism of such contactors is designed to be so strong, and the movement of the contact bridges cover such great areas, that no adjustment outlay for adjusting the contacts is required. The drive mechanism is provided with a corresponding considerable control current. So that contact can be dependably made and broken over a long period of time, the contact bridges are resiliently seated. However, this also results in long switching paths. These contactors do not have a control contact. The switching position of the contactor can be monitored by means of adding an electronic add-on contact, for example. However, the disadvantage of these contactors lies in their size which, for example, does not permit the fastening of the contactor on a board of an electronic control device.

Relays of the type mentioned at the outset, however, are embodied to be substantially smaller, and the force relations between the spring force and the drive mechanism are greatly balanced. Therefore a considerable effort is made for adjusting the spring elements. Up to now, such relays had at least one control contact which was constructed similar to or identical to the load contacts and was operated by means of the same slide as the load contacts. In this relay the control contact must be a break-contact element, if the working contact is a make-contact element, or a make-contact element, if the working contact is a break-contact element. In the course of this it is possible to assure that the control contact cannot be closed if the load or working contact is welded shut, or does not otherwise open when it should.

The disadvantage of conventional monitoring of the switching position of the load contact of a relay by means of a control contact lies in that either the drive mechanism must be made very strong, or the control contact must be adjusted. Both affect the price of the relay. Selecting a strong drive over a reduced adjustment outlay moreover has an effect on the size of the relay. Conversely, selecting a minimal drive mechanism results in an increased adjustment outlay, which entails relatively high costs.

An electromechanical switching device is known from DE 199 60 399. This is a safety relay module intended for safety shut-down in particular. The switching device has at least one mechanical switching contact. An optical sensor is provided in the switching device, which monitors the switching position of the switching contact, so that a mutual positive guidance of the switching contact together with a control contact can be omitted, while a high degree of safety can still be achieved. The sensor is an optical sensor comprising a transmitter for emitting a lightbeam and a light-sensitive receiver. In this case the lightbeam is located on a level on which the contact faces of the switching contact meet when the switching contact is closed. But the lightbeam can also be located on a level on which a switching contact pin of the switching contact is located in the closed or open state. It is alternatively possible to design the sensor as a reflecting optical barrier. For this purpose a reflecting surface is provided on the contact pin.

This construction is only suitable for monitoring a single contact. However, for monitoring several contacts of a safety relay module placed side-by-side, this publication proposes the provision of a bifurcated optical barrier, whose lightbeam emanating from the transmitter passes through the make-contact elements arranged side-by-side in the area of the contact faces.

Such monitoring is not suitable for relays having both make-contact and break-contact elements in series. This monitoring can also not indicate that one of the make-contact elements arranged side-by-side is still open, when only a single one is closed. This type of monitoring most of all requires a line-up of the contacts along a line extending transversely to the movement direction of the switching contact pins. It is therefore not possible in connection with a relay monitored in this way to actuate break-contact and make-contact elements by means of a common slide. Moreover, such monitoring is only optically possible. Furthermore, when monitoring a contact in the area of the contact faces by means of an optical sensor, it is only possible by means of a dynamic operation of the monitoring device to make it impossible that an electrical spark from a contact triggers a false signal. Also, an optical sensor arranged in the area of the contacts is subject to soiling. For meeting requirements in respect to potential separation between a sensor in the area of elements through which a load current is conducted and these elements, considerable structural outlay or spatial dimensions are moreover required. Furthermore, with such an arrangement it is necessary to place all contact faces exactly in a line, so that the optical sensor device still indicates that the contacts are separated even at a distance of only one-half millimeter. To achieve this, an increased outlay for adjustment must be expected.

### SUMMARY OF THE INVENTION

It is an object of the invention to create a relay of the type mentioned at the outset with which a plurality of contacts, which can be actuated via a mutual slide, can be monitored by means of a common monitoring device, regardless of whether they are make-contact or break-contact elements. It is intended to keep the costs of the drive mechanism, as well as of the adjustment effort, low. It is to be made possible to reduce the adjustment outlay without strengthening the drive mechanism or, to reduce the drive mechanism without increasing the adjustment outlay. The drive mechanism and adjustment outlay can even be advantageously reduced.

In accordance with the invention, the monitoring device is a monitoring device which can be operated contactless and has at least one sensor arranged in the housing in the vicinity of the slide which positively guides the contacts, and at least one activator of the sensor arranged on the slide. Therefore a mechanical control contact operated by means of the same slide can be omitted. Accordingly, the contact spring of this control contact need not be moved, so that the power of the drive mechanism can be reduced. Moreover, at least one less contact spring needs to be adjusted. Monitoring the position of the slide has the advantage that the contactless operating monitoring device need not be arranged in the soil-generating part of the contact chambers. This furthermore permits an optimal separation of the load circuit and the control circuit in the relay.

Since the contacts are mutually positively guided by means of the slide, the position of the sensor in the vicinity of the slide and the arrangement or design of the activator on, at or in the slide makes it possible to simultaneously monitor all contacts being switched by the common slide. If a single contact remains in a position, the slide remains in this position, and with it all the other contacts.

The monitoring device of the relay in accordance with the invention switches, generates or alters a current, or its voltage, by means of one of the phenomena of light, magnetism or capacitance. The signal generated in this way can now be used to monitor the position or movement of the slide, and therefore of the contact.

Such monitoring devices are, for example:

a light-emitting element (transmitter) and a light-sensitive element (sensor) on this side and the other side of an interrupting element (activator in the form of a reflector or window), which is moved together with the slide into the lightbeam,

an electromagnet (transmitter) generating an alternating magnetic field, and a second electromagnet (sensor), in which a current is induced via the alternating magnetic field via a metal bridge (activator), which can be displaced into the magnetic field by means of the slide,

an induction loop (transmitter), which forms a magnetic field and monitors a movement of a metal element (activator) moving with the slide,

a passive induction loop (transmitter), which monitors a movement of a permanent magnet (activator) moving with the slide,

a reed contact (sensor), which reacts to a magnet (activator) displaceable by means of the slide; a reed switch can be employed as a break-contact element, make-contact element or changer in a known operating manner,

a magnetic field-dependent resistor (sensor), which responds to a permanent magnet (activator) movable by means of the slide,

a Hall generator (sensor) within the range of influence of a magnet (activator) displaceable together with the slide.

A relay, in which the switching of the load contacts is monitored, can have a monitoring device for monitoring the position or movement of the slide. It is possible to generate an electrical current, or to change a preset electrical signal, by means of the monitoring device.

Monitoring devices of this type are, in addition to the above mentioned contactless exemplary embodiments, also the following exemplary embodiments operating by contact:

a piezo crystal which is under pressure in one of the end positions of the slide, and

sliding resistor, whose resistance is changed by displacing the slide.

Therefore a signal capable of being evaluated can be generated by:

generating a voltage, for example by pressure on a piezo crystal or by exposing a Hall generator to a magnetic field,

triggering a current flow, for example by illuminating a photo cell or a photo resistor, or actuating a reed switch by the approach of a magnet toward the switching plates of the reed switch,

altering a current flow, for example by illuminating a photo resistor or a photo transistor,

altering a voltage, for example by illuminating a photo resistor or a photodiode,

altering the capacity of a capacitor by changing the relative position of the two statically charged metal layers,

altering an induced current by moving a magnetic field or a metal element in the magnetic field,

inducing a current in an induction loop by the movement of a magnetic field in respect to the induction loop,

inducing a current in an induction coil by transmitting an alternating magnetic field to the core of the coil,

altering a resistance in a magnetic field-dependent resistor by changing the position of a magnetic field in relation to the resistor component.

This listing is not exclusive.

It is advantageously possible with many of these monitoring devices to perform their adjustment, should it be required at all, electronically, for example in a component present in the relay, or also outside of the relay, and in this way to set the output signal from the monitoring device to a selectable value. The signal value occurring within a bandwidth as a result of the production can also be individually read onto the respective position of the relay when the relay is employed, for example by means of an appropriate setting of a user program.

The location of the monitoring device within the relay is freely selectable. It is possible to provide one, two or more monitoring devices in the relay. The signals from such monitoring devices can be variably and user-specifically employed.

Individual exemplary embodiments will be described in what follows by means of schematic representations.

### BRIEF DESCRIPTION OF THE DRAWINGS

The invention will be described in further detail below in conjunction with the drawings. The drawings, not to scale, show the following:

FIG. 1 shows a relay with two closed make-contact elements as the load contacts and an optoelectric monitoring device,

FIG. 2 shows the relay in FIG. 1 with opened load contacts,

FIG. 3 represents a relay with one make-contact element and one break-contact element and two optoelectric monitoring devices,

FIG. 4 represents an inductive monitoring device with two electromagnetic coils and two movable iron bridges,

FIG. 5 shows the monitoring device in FIG. 4 with the iron bridges displaced,

FIG. 6 shows two reed switches with a permanent magnet which simultaneously activates both,

FIG. 7 represents two reed switches with a permanent magnet which activates either one or the other reed switch,

FIG. 8 shows a slide with a capacitor face, which can be displaced in relation to the other capacitor face,

FIG. 9 shows the slide in FIG. 8 in a displaced position,

FIG. 10 represents a passive induction loop with a permanent magnet which can be displaced relative to the loop,

FIG. 11 represents an induction loop which excites an alternating magnetic field and has an iron element, which can be displaced in relation thereto,

FIG. 12 is an induction coil arrangement with several separate induction loops and a magnet which can be displaced relative to them,

FIG. 13 is a second induction coil arrangement with several separate active induction loops and an iron rod which can be displaced relative to them.

### DETAILED DESCRIPTION OF THE PREFERRED EMBODIMENTS

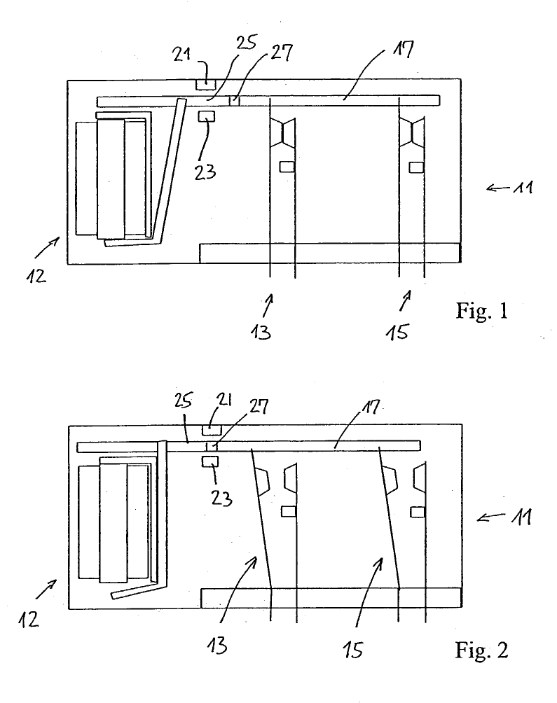

FIG. 1 schematically represents a relay 11 with two switching contacts 13, 15. These are in engagement with a mutual slide 17 and are positively conducted by it. The slide is controlled by an electromagnetic drive mechanism 12. Positive conducting assures that either all or no contacts 13, 15 participate in the switching movement. It is therefore possible to read off from the slide 17 whether the contacts 13, 15 are open or closed. It should be possible to detect the information regarding the position of the slide 17 electrically or electronically.

Up to now, at least one of the contacts of the relay was used for this. By means of this it can be determined whether the load contacts are opened or closed. It should be closed when the load contacts are open, and open, when they are closed.

As a rule, this is manually performed by the trained application of a force to a contact spring of the control contact, which bends the contact spring.

In FIG. 1, monitoring of the position of the slide 17 is performed by means of an optoelectric component. This comprises a light-emitting diode 22, a light-sensitive element 23 which, because of the effect of light, also emits a signal, and an interrupter 25. In this case the interrupter is constituted by the slide 17 itself. An opening 27 for light is provided in the slide 17. In FIG. 1, the lightbeam triggering the signal is interrupted by the slide 17, since the contacts 13, 15 are closed. But in FIG. 2 the opening 27 for light is located between the light-emitting diode and the signal-emitting element 23, because the contacts 13, 15 are open.

The lightbeam can also be deflected by the interrupter. In this case it can be directed to various signal-emitting elements 23.

If the signal-emitting element 23 is sensitive to the amount of the impinging light, it is possible to detect intermediate positions of the slide. Such threshold value monitoring can be set electronically and adjusted. This adjustment can be performed internally in the relay or on the part of the user outside of the relay. However, if the signal-emitting element 23 can only detect the presence or absence of light, only one of the end positions, namely the open position, can be detected. Possible differences in the signal strength can be electronically corrected.

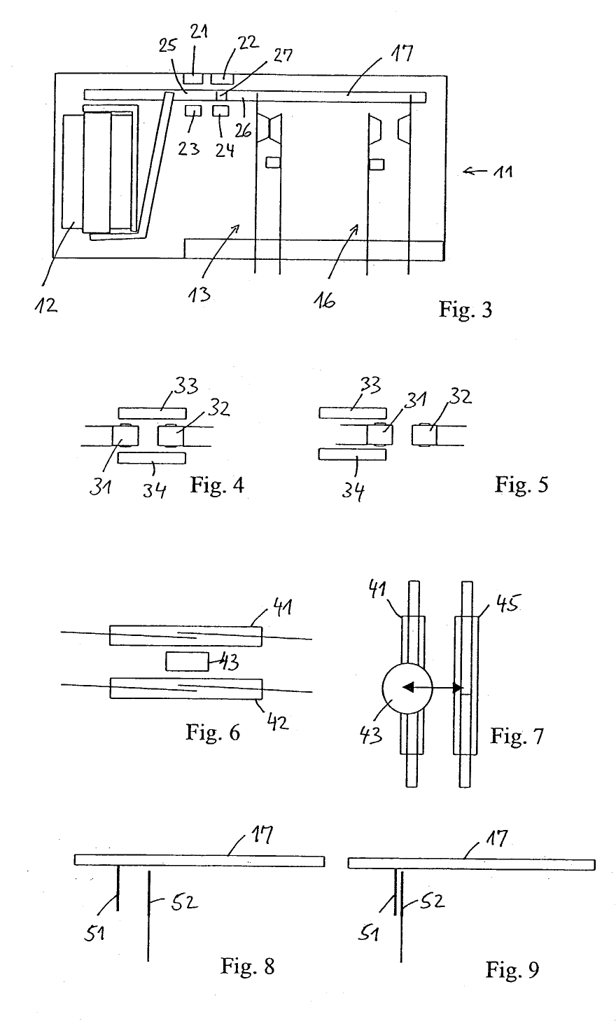

An activated relay 11 with a make-contact element 13 and a break-contact element 16 is represented in FIG. 3. A first optoelectric component 21, 23 with the opening 27 for light in the slide 17 and a first interrupter 25 is provided for monitoring the make-contact element 13. A second optoelectric component 22, 23 with the same opening 27 for light in the slide and a second interrupter 26 is provided for the break-contact element 16.

Monitoring can also be performed in the opposite way, namely such that the interruption of the lightbeam triggers a signal. In that case, with two signal-emitting elements 23, 24 there are two openings for light and between them an interrupter, which can be pushed over one or the other signal-emitting element 23, 24. However, for reasons of dependability the represented embodiment is preferable, because the loss of the light emission caused, for example, by a defect in the current supply, causes the signal which indicates closed contacts. In safety applications of positively conducted relays this position is the relevant position.

For adjusting the monitoring device it is merely necessary to adjust the location of the light-emitting component and of the light-receiving component. These adjustments are achieved by the local displacement of the element, which is considerably simpler in comparison with bending the contact spring.

In place of the optoelectric component it is also possible to use a component operating by induction. An embodiment variation with inductive detection of the position of the slide is represented in FIGS. 4 and 5. The induction component in accordance with FIGS. 4 and 5 has a first coil 31 with a core and a second coil 32 with a core, which coils 31, 32 are arranged parallel with each other side-by-side. During operation the first coil 31 is supplied with alternating current. The alternating magnetic field being created by this is partially detected by the adjoining second coil 32, so that an alternating current is induced in its windings, which is weaker than the one fed into the first coil 31. The magnetic field is deflected by displacing an iron bridge 33 into the area of the respective core ends of the two coils 31, 32. Therefore, depending on the position of the bridge 33, a stronger (FIG. 4) or weaker alternating current (FIG. 5) is induced in the second coil 32. Two bridges 33 and 34 are provided in FIGS. 4 and 5, one of which attracts the magnetic field at the one pole, and the other at the other pole.

Therefore the bridge 33 is effectively displaced with the slide 17. The induced current can now be measured and the position of the slide calculated from this. By suitable steps taken in software connected with the relay 11, the adjustment of the bridge 33 and of the coils 31, 32 can be totally performed by electronic means in that, for example, the measured values are related to the position of the contacts 13, 15, 16. This advantage can be used with all embodiments generating signals which change with the displacement position of the slide 17.

However, it is also possible to obtain a switching signal with only two switching states in a contactless manner. To illustrate this, an example is represented in FIGS. 6 and 7, in which a reed switch 41 is connected in a manner known per se with a permanent magnet 43. The permanent magnet 43 is displaced together with the slide 17. In the course of this it comes into the vicinity of the reed switch 41 and switches it. For dependability, two reed switches 41, 42 can be switched simultaneously. But two reed switches 41, 45 can also be switched in series. With this it is possible, for example, to monitor a break-contact element, as well as a make-contact element, by the movement of a single magnet 43. For adjusting a reed switch 41, either its position or that of the magnet 43 can be changed. The magnet 43, whose position was changed in respect to the reed switches, can switch the reed switch 41 by overlying a constantly existing magnetic field which is oriented in the opposite direction and closes the reed switch.

An example is represented in FIGS. 8 and 9, wherein the position of the slide 17 is capacitively detected. For this purpose the slide 17 has a capacitor plate 51 which, by means of the slide, can be displaced in respect to a second capacitor plate 32. Because of the position change, the characteristic value which can be measured at the capacitor also changes. This value which is different, depending on the operational accuracy, can be electronically adjusted or can be assigned by software to the position of the contacts.

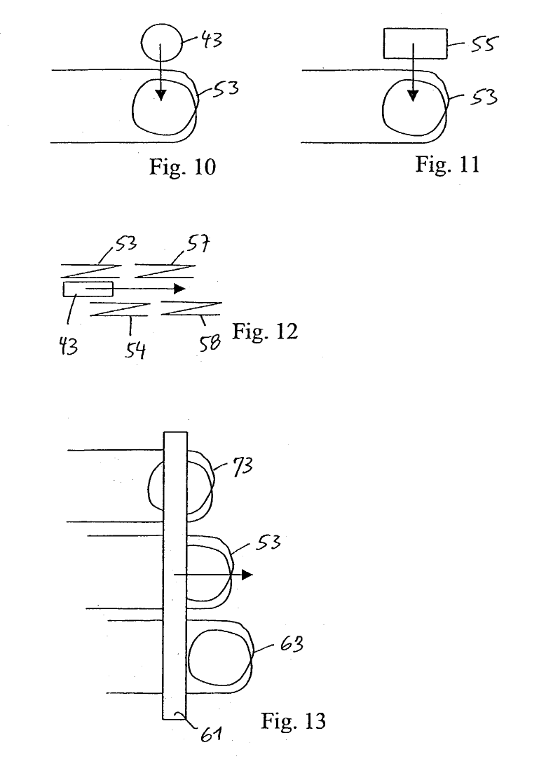

A magnet 43 is represented in FIG. 10, which can be displaced by means of the slide 17 in respect to an activated induction loop 53. In FIG. 11 a metallic element 55 can be displaced in relation to an activated induction loop 53. By means of these arrangements it is possible to detect a movement of the slide. In FIG. 12 it is shown that several induction loops 53, 54, 57, 58 on both sides of a magnet 43 (or metallic element) can be arranged side-by-side in the movement direction, others of which come into the range of influence of the displaceable magnet 43 at different strength. It is possible by means of this not only to detect the movement, but also the position of the slide 17.

FIG. 13 shows that the loops 53, 63, 73 can also be arranged side-by-side transversely to the movement direction in order to detect the position and movement of a rod 61, which can be connected with the slide 17.

In conclusion the following can be said: an activator is arranged on, in or at a slide which is common to the contacts of a relay. A sensor, which can be activated by means of the activator, is arranged in the vicinity of the slide. By means of the contactless generation of a control signal by means of the activator in the sensor during the monitoring of the switched position, or the switching movement of the contacts, an adjustment of the monitoring device is possible electronically and/or by the change of the location of the elements of the monitoring device. This reduces the adjustment outlay considerably and allows the reduction of the drive mechanism, since fewer springs need to be moved and therefore the force required for switching the relay is reduced.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A relay, having a housing, and having in the housing:
a number of load contacts, each with a movable contact spring;
a slide, which is in positive engagement with each movable contact spring of the load contacts;
a drive mechanism for driving the slide for switching the load contacts by means of the slide; and
a monitoring device in the housing of the relay for monitoring the switching of the load contacts, the monitoring device having at least one sensor arranged in the housing in a vicinity of the slide, and having at least one activator of the sensor arranged or embodied on, in or at the slide.

2. The relay of claim 1, wherein the monitoring device is laid out in such a way that a movement of the slide triggers a signal in the monitoring device.

3. The relay of claim 1, wherein the monitoring device is laid out in such a way that, depending on a position of the slide in the monitoring device, a definable signal is triggered.

4. The relay of claim 1, wherein a signal is capacitively triggered in the monitoring device.

5. The relay of claim 1, wherein a signal is optoelectrically triggered in the monitoring device.

6. The relay of claim 5, wherein a reflector is arranged on the slide to reflect in one position of the slide a lightbeam emitted by a transmitter to a receiver.

7. The relay of claim 5, wherein an interrupter is embodied on the slide which, in one position of the slide, interrupts a lightbeam emitted by a transmitter, and in another position allows the lightbeam to reach a receiver.

8. The relay of claim 1, wherein a signal is inductively triggered in the monitoring device.

9. The relay of claim 1, wherein a signal is magnetically triggered in the monitoring device.

10. The relay of claim 2, wherein the monitoring device is laid out in such a way that, depending on a position of the slide in the monitoring device, a definable signal is triggered.

11. The relay of claim 10, wherein a signal is capacitively triggered in the monitoring device.

12. The relay of claim 10, wherein a signal is optoelectrically triggered in the monitoring device.

13. The relay of claim 12, wherein a reflector is arranged on the slide to reflect in one position of the slide a lightbeam emitted by a transmitter to a receiver.

14. The relay of claim 12, wherein an interrupter is embodied on the slide which, in one position of the slide, interrupts a lightbeam emitted by a transmitter, and in another position allows the lightbeam to reach a receiver.

15. The relay of claim 10, wherein a signal is inductively triggered in the monitoring device.

16. The relay of claim 10, wherein a signal is magnetically triggered in the monitoring device.
